(19) United States
(12) Patent Application Publication
(10) Pub. No.: US 2012/0324117 A1
(43) Pub. Date: Dec. 20, 2012

(54) ELECTRONIC DEVICE AND METHOD FOR PROVIDING NETWORK CONNECTIONS USING THE ELECTRONIC DEVICE

(75) Inventor: FENG-SUI CHUANG, Tu-Cheng (TW)

(73) Assignee: CHI MEI COMMUNICATION SYSTEMS, INC., Tu-Cheng (TW)

(21) Appl. No.: 13/450,738

(22) Filed: Apr. 19, 2012

(30) Foreign Application Priority Data
Jun. 15, 2011 (TW) 100120820

(51) Int. Cl. G06F 15/16; H04W 76/02

(52) U.S. Cl. 709/227

(57) ABSTRACT

A method for providing a plurality of network connections using an electronic device presets a first Access Point Name (APN) to connect the electronic device to a wireless network. A first transmission channel is established and activated to transmit data between a first application and the wireless network according to the first APN, in response to determining that the first application has a need to access the wireless network. The method further creates a second APN if a second application in the electronic device needs to access the wireless network while the first transmission channel is activated. A second transmission channel is established and activated to transmit data between the second application and the wireless network according to the second APN.

### BACKGROUND

1. Technical Field

Embodiments of the present disclosure relate to network connection management technology, and particularly to an electronic device and method for providing a plurality of network connections using the electronic device.

2. Description of Related Art

An electronic device (e.g., a cell phone, a personal digital assistant, a tablet computer) can provide multiple functions, such as making phone calls, transmitting messages, watching videos online, browsing web pages, for example. Specific data from the Internet or other communication networks (e.g., Global System for Mobile Communications (GSM), general packet radio service (GPRS), third generation mobile telecommunications (3G)) can be acquired by using the electronic device.

However, the electronic device may be incapable of providing more than one network connection at the same time, to support all the functions of applications in the electronic device. In other words, if the electronic device is already connected to a specific wireless network, connecting to another network connection of the electronic device will interrupt the first specific wireless network. For example, when watching streaming video on line, the streaming video will be interrupted if the electronic device receives a short message service (SMS) message. This is annoying and sometimes very inconvenient.

### BRIEF DESCRIPTION OF THE DRAWINGS

FIG. 1 is a block diagram of one embodiment of an electronic device including a coexistence system.

FIG. 2 is a flowchart of one embodiment of a method for providing a plurality of network connections using the electronic device of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

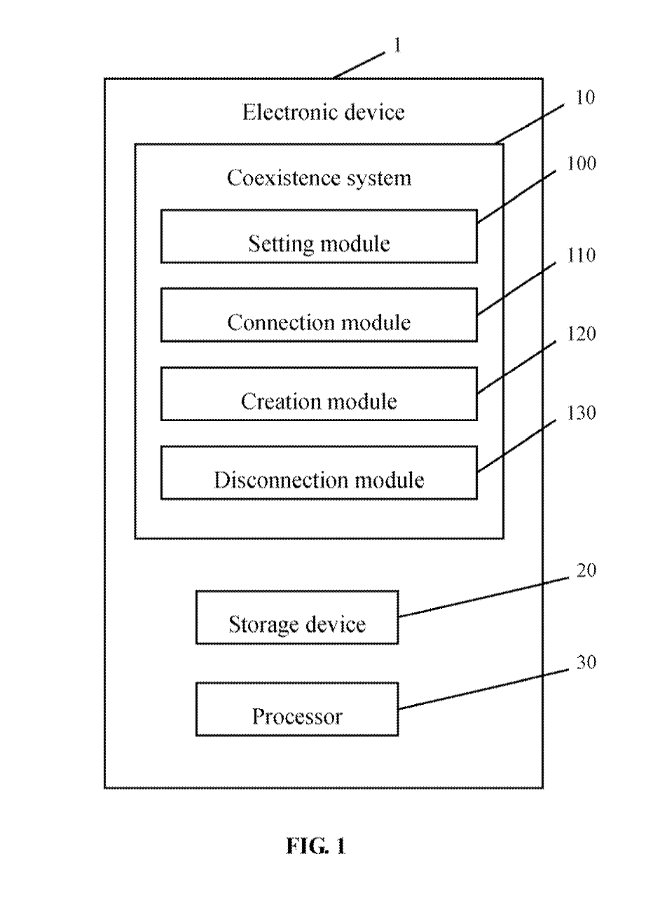

FIG. 1 is a block diagram of one embodiment of an electronic device 1 including a coexistence system 10. The electronic device 1 may be a communication device (e.g., a cell phone), a personal digital assistant (PDA), a tablet computer, or a personal computer. In some embodiments, the electronic device 1 may be connected to different kinds of wireless networks, such as the Internet, an intranet, the Global System for Mobile Communications (GSM) network, the general packet radio service (GPRS) network, the third generation mobile telecommunications (3G), or any other communication network provided by different service providers. In some embodiments, the electronic device 1 has necessary hardware components to connect the above mentioned wireless networks. For example, the electronic device 1 may have a GSM modem to connect the electronic device 1 to the GSM network.

The coexistence system 10 may be used to provide a plurality of coexisting network connections for connecting a plurality of applications in the electronic device 1 to different wireless networks. A detailed description of the coexistence system 10 will be given in the following paragraphs.

The electronic device 1 further includes a storage device 20 providing one or more memory functions, and at least one processor 30. In one embodiment, the coexistence system 10 may include computerized instructions in the form of one or more programs that are executed by the at least one processor 30 and stored in the storage device 20.

The storage device 20 stores one or more programs, such as programs of the operating system, other applications of the electronic device 1, and various kinds of data, such as images and videos. In some embodiments, the storage device 20 may include a memory of the electronic apparatus 10 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components.

In one embodiment, the coexistence system 10 may include one or more modules, for example, a setting module 100, a connection module 110, a creation module 120, and a disconnection module 130. In general, the word “module”, as used herein, refers to logic embodied in hardware or firmware, or to a collection of software instructions, written in a programming language, such as, Java, C, or assembly. One or more software instructions in the modules may be embedded in firmware, such as in an

EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The setting module 100 presets a first Access Point Name (APN) to connect the electronic device 1 to a wireless network. In some embodiments, APN is a computer protocol that allows a computer (e.g., the electronic device 1) to access the Internet using the mobile phone network. In some embodiments, the first APN may be represented by a number, such as 40, for example. The wireless network may be a designated network, or any other suitable network that the electronic device 1 needs to be connected to.

The setting module 100 may further preset the first APN to be a default APN to connect the electronic device 1 to the wireless network. The default APN may be used first whenever any application in the electronic device 1 needs to connect to the wireless network.

In response to determining that a first application has a need to access the wireless network, the connection module 110 establishes a first transmission channel according to the first APN, and activates the first transmission channel to transmit data between the first application and the wireless network. In some embodiments, the first transmission channel conforms to a first packet data protocol (PDP) context. The PDP context is a data structure present on both the Serving GPRS Support Node (SGSN) and the Gateway GPRS Support Node (GGSN). The GGSN contains a subscriber's session information when the subscriber is having an active session. When a cell phone wants to use the GPRS, the cell phone needs to first attach and then activate a PDP context.

The first APN corresponds to a PDP context, and is used to activate the PDP context. In some embodiments, the first APN may be carried by an activate PDP context request message sent from the electronic device 1 to the wireless network.

In some embodiments, the connection module 110 may determine whether the first application has a need to access the wireless network by detecting user operations on the plurality of applications in the electronic device 1. The first application may be a web browser, or a Multimedia Messaging Service (MMS), or an online video player, or any other program or software stored in the electronic device 1. For example, the connection module 110 may detect if a MMS message is being sent, or if the web browser is being activated.

If a second application in the electronic device 1 then has a need to access the wireless network while the first transmission channel is activated, the creation module 120 creates a second APN.

The connection module 110 further establishes a second transmission channel according to the second APN, and activates the second transmission channel to transmit data between the second application and the wireless network. The second transmission channel is coexistent with the first transmission channel. Similarly, the second transmission channel also conforms to the PDP context. For example, the first transmission channel may be connected to the GSM network, and the second transmission channel may be connected to the Internet.

In some embodiments, a service provider provides a plurality of transmission channels, and one of the transmission channels may be allocated to the electronic device 1 according to received APN.

The above mentioned wireless network may be same or different. In other words, different wireless networks provided by different service providers may each provide one or more transmission channels for connection to the electronic device 1 using above mentioned modules in the coexistence system 10.

The disconnection module 130 deactivates one or more idle transmission channels to release resources of the electronic device 1. In some embodiments, the disconnection module 130 deactivates the first transmission channel under the condition that the first application has no need to access the wireless network, or deactivates the second transmission channel under the condition that the second application has no need to access the wireless network. For example, if the first or second application is closed or is finished executing, the first or second application would be regarded as having no need to access the wireless network. By deactivating idle transmission channels, speed of network access may also be improved, and buffering time may be reduced.

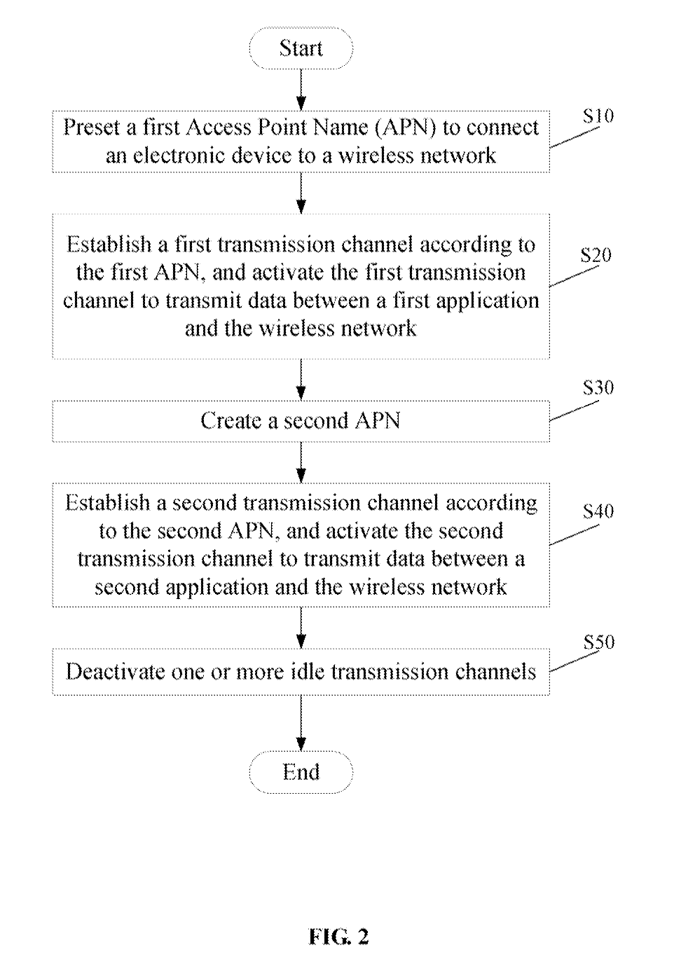

FIG. 2 is a flowchart of one embodiment of a method for providing a plurality of network connections using the electronic device 1 of FIG. 1. Depending on the embodiment, additional steps may be added, others removed, and the ordering of the steps may be changed.

In step S10, the setting module 100 presets a first Access Point Name (APN) to connect the electronic device 1 to a wireless network.

In response to determining that a first application has a need to access the wireless network, in step S20, the connection module 110 establishes a first transmission channel according to the first APN, and activates the first transmission channel to transmit data between the first application and the wireless network.

In step S30, the creation module 120 creates a second APN under the condition that a second application in the electronic device 1 also has a need to access the wireless network while the first transmission channel is activated.

In step S40, the connection module 110 establishes a second transmission channel according to the second APN, and activates the second transmission channel to transmit data between the second application and the wireless network.

In step S50, the disconnection module 130 deactivates one or more idle transmission channels to release resources of the electronic device 1. As mentioned above, the disconnection module 130 deactivates the first transmission channel under the condition that the first application has no need to access the wireless network, or deactivates the second transmission channel under the condition that the second application has no need to access the wireless network.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for providing a plurality of network connections using an electronic device comprising a processor, the method comprising execution of the steps comprising:
presetting a first Access Point Name (APN) to connect the electronic device to a wireless network;
establishing a first transmission channel according to the first APN, and activating the first transmission channel to transmit data between a first application and the wireless network, in response to determining that the first application has a need to access the wireless network;
creating a second APN under the condition that a second application in the electronic device has a need to access the wireless network while the first transmission channel is activated; and
establishing a second transmission channel according to the second APN, and activating the second transmission channel to transmit data between the second application and the wireless network, the second transmission channel being coexistent with the first transmission channel.

2. The method according to claim 1, further comprising:
deactivating the first transmission channel under the condition that the first application has no need to access the wireless network; or
deactivating the second transmission channel under the condition that the second application has no need to access the wireless network.

3. The method according to claim 1, further comprising:
presetting the first APN as a default APN to connect the electronic device to the wireless network.

4. The method according to claim 1, wherein the first transmission channel and the second transmission channel conform to a first packet data protocol (PDP) context.

5. The method according to claim 4, wherein the first APN and the second APN are carried by an activate PDP context request message sent to the wireless network.

6. The method according to claim 1, wherein the first application or the second application is a web browser, a Multimedia Messaging Service (MMS), or an online video player.

7. An electronic device, comprising:
a storage device;
at least one processor; and
one or more modules that are stored in the storage device and executed by the at least one processor, the one or more modules comprising:
a setting module that presets a first Access Point Name (APN) to connect the electronic device to a wireless network;
a connection module that establishes a first transmission channel according to the first APN, and activates the first transmission channel to transmit data between a first application and the wireless network, in response to determining that the first application has a need to access the wireless network;
an creation module that creates a second APN under the condition that a second application in the electronic device has a need to access the wireless network while the first transmission channel is activated; and
the connection module further establishes a second transmission channel according to the second APN, and activates the second transmission channel to transmit data between the second application and the wireless network, the second transmission channel being coexistent with the first transmission channel.

8. The electronic device according to claim 7, wherein the one or more modules further comprise a disconnection module that deactivates the first transmission channel under the condition that the first application has no need to access the wireless network, or deactivates the second transmission channel under the condition that the second application has no need to access the wireless network.

9. The electronic device according to claim 7, wherein the setting module further presets the first APN as a default APN to connect the electronic device to the wireless network.

10. The electronic device according to claim 7, wherein the first transmission channel and the second transmission channel conform to a first packet data protocol (PDP) context.

11. The electronic device according to claim 10, wherein the first APN and the second APN are carried by an activate PDP context request message sent to the wireless network.

12. The electronic device according to claim 7, wherein the first application or the second application is a web browser, a Multimedia Messaging Service (MMS), or an online video player.

13. A non-transitory storage medium having stored instructions that, when executed by a processor of an electronic device, causes the electronic device to perform a method for providing a plurality of network connections using the electronic device, the method comprising:
presetting a first Access Point Name (APN) to connect the electronic device to a wireless network;
establishing a first transmission channel according to the first APN, and activating the first transmission channel to transmit data between a first application and the wireless network, in response to determining that the first application has a need to access the wireless network;
creating a second APN under the condition that a second application in the electronic device has a need to access the wireless network while the first transmission channel is activated; and
establishing a second transmission channel according to the second APN, and activating the second transmission channel to transmit data between the second application and the wireless network, the second transmission channel being coexistent with the first transmission channel.

14. The non-transitory storage medium according to claim 13, wherein the method further comprises:
deactivating the first transmission channel under the condition that the first application has no need to access the wireless network; or
deactivating the second transmission channel under the condition that the second application has no need to access the wireless network.

15. The non-transitory storage medium according to claim 13, wherein the method further comprises:
presetting the first APN as a default APN to connect the electronic device to the wireless network.

16. The non-transitory storage medium according to claim 13, wherein the first transmission channel and the second transmission channel conform to a first packet data protocol (PDP) context.

17. The non-transitory storage medium according to claim 16, wherein the first APN and the second APN are carried by an activate PDP context request message sent to the wireless network.

18. The non-transitory storage medium according to claim 13, wherein the first application or the second application is a web browser, a Multimedia Messaging Service (MMS), or an online video player.
